(19) United States
(12) Patent Application Publication
(10) Pub. No.: US 2006/0069922 A1
(43) Pub. Date: Mar. 30, 2006

(54) Visual authentication of user identity

(75) Inventors: Lenka M. Jelinek, Portland, OR (US); Muthu K. Kumar, Hillsboro, OR (US); Gunner D. Danneels, Beaverton, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/953,118

(22) Filed: Sep. 30, 2004

(51) Int. Cl. H04K 1/00

(52) U.S. Cl. 713/186; 705/64

(57) ABSTRACT

An apparatus for visually authenticating a user, the apparatus including a digital device, a camera coupled to said digital device, and an identity module coupled to said digital device and including a secured memory with a photo image of the user stored therein.

### BACKGROUND OF THE INVENTION

Digital devices have become ubiquitous. For example, wireless telephones in general, and more particularly GSM (i.e., Global System for Mobile communications) wireless telephones are nearly everywhere. This second-generation digital technology, which was originally developed for Europe, now has in excess of 71 percent of the world market.

The growth of GSM and other mobile communication systems continue unabated. Additionally, GSM and other mobile communication systems continue to evolve. Many such systems already offer an expanded and feature-rich family of voice and/or data enabling services, which may include, but are not limited to, electronic funds transfer and other forms of mobile commerce, or “m-commerce”.

As in all forms of commerce, fraud management is a key concern. For example, this concern is particularly so in the m-commerce environment, where wireless communications devices are susceptible to theft or to use by people not their owners. Further, in traditional commerce, there remains an ongoing concern over credit card fraud.

### BRIEF DESCRIPTION OF THE DRAWINGS

Exemplary embodiments of the invention will now be described in connection with the associated drawings, in which:

FIG. 1 depicts an exemplary embodiment of a first system for authentication of user identity;

FIG. 2 depicts an enlarged view of an identity module that may be used in the system of FIG. 1, according to an embodiment of the invention;

FIG. 3 depicts an exemplary embodiment of a method for authenticating a commercial transaction according to an embodiment of the invention;

FIG. 4 depicts an exemplary embodiment of a method for authenticating a digital transaction according to an embodiment of the invention; and

FIG. 5 depicts a further exemplary embodiment of an identity module which may be used according to embodiments of the present invention.

### DETAILED DESCRIPTION OF VARIOUS EMBODIMENTS

As used herein, references to “one embodiment”, “an embodiment”, “example embodiment”, “various embodiments”, etc., may indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “connected” and “coupled,” along with their derivatives, may be used. It should be understood that these terms may not be intended as synonyms for each other. Rather, in particular embodiments, “connected” may be used to indicate that two or more elements are in direct physical or electrical contact with each other. In contrast, “coupled” may mean that two or more elements are in direct physical or electrical contact with each other or that the two or more elements are not in direct contact but still cooperate and/or interact with each other.

An algorithm is here, and generally, considered to be a self-consistent sequence of acts or operations leading to a desired result. These operations include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general-purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Exemplary embodiments of the invention may provide enhanced features for chip cards, such as, e.g., Subscriber Identity Module (SIM) cards. In an exemplary embodiment of the invention, a photo image may be added to a secured, encrypted, and/or protected memory of the chip card.

FIG. 1 depicts a system in which exemplary embodiments of the present invention may be implemented. In FIG. 1, the system may include a digital device 100, which may have a camera (not shown), and an identity module 200. Digital device 100 may suitably comprise, but is not limited to, any electronic computing device and/or electronic communications device, such as a wireless telephone, a personal digital assistant (PDA), or a personal computer. Device 100 may also have a subscriber identity module SIM card, which may suitably comprise identity module 200, coupled thereto. Device 100 may also be used to communicate with a point-of-sale (POS) terminal 104 having a display 106, such as by means of the well-known standards of Bluetooth® (a registered trademark of Bluetooth SIG, Inc.) or IRDA® (a registered trademark of the Infrared Data Association); however, the invention is not limited to these standards.

In addition to the functions available on typical wireless communication devices, such as digital device 100, a user's SIM card 200 may provide further services that the user may access by way of conventional menus, for example. Such menus may be shown on the display 102 of the device 100 only if supported by the user's SIM card 200. The name and contents of a menu may depend on the service available. For availability, rates, and information on using SIM services, a user may contact the user's service provider.

SIM cards such as identity module 200 may have certain features that may provide customers with various conveniences and security. A SIM card may, for example, measure about 1 inch by ⅝ inch, may be thinner than a dime, and may slip into a sleeve inside a handset, e.g., behind the handset's battery.

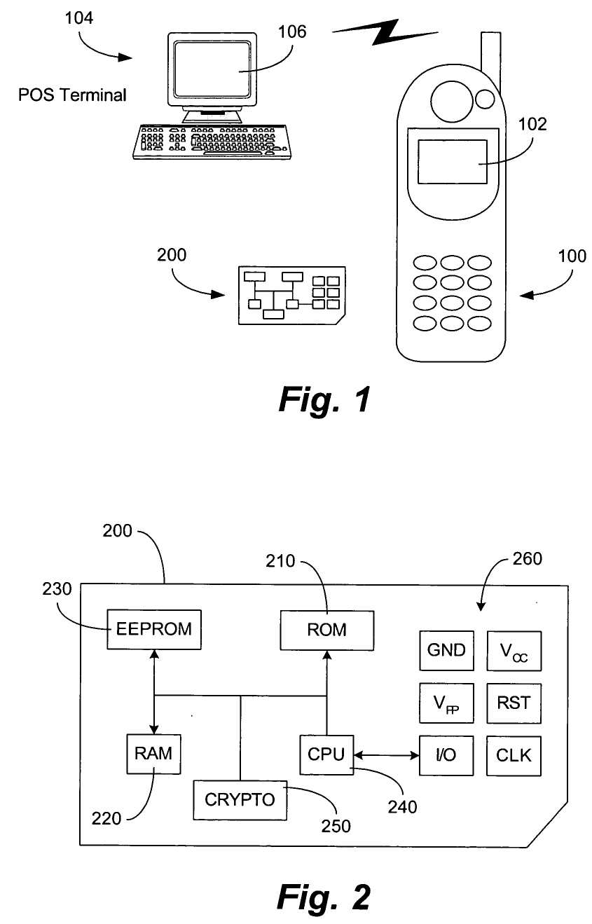

A SIM card 200, an embodiment of which is shown in FIG. 2, may comprise memory, which may vary in capacity from about 32 kBytes to about 128 kBytes, but which is not limited to this range. SIM card 200 may have three memory areas. The first memory area may contain the SIM card's operating system at ROM 210. The second memory area may work as a scratch pad and may function as the SIM card's RAM 220. The third memory may be an EEPROM 230, within which the user's account information and personal information (e.g., phone book and stored SMS messages) may be stored. In an exemplary embodiment of the invention, this third memory EEPROM 230 may represent the secured, encrypted and/or protected memory of SIM 200.

SIM card 200 may further comprise a processor or CPU 240. A dedicated crypto co-processor 250 may also allow the execution of crypto-algorithms, which may include asymmetric crypto-algorithms and which may enable the card to play a major role in the application of public key infrastructures (PKI) to regulate the use of certificates for authentication in traditional, electronic and/or mobile transactions.

Each SIM card 200 may also include a plurality of contacts 260. For example, contact V_{CC} may provide a supply voltage for SIM 200; contact RST may provide a reset signal for SIM 200; contact CLK may provide a clock signal for SIM 200; contact GND may provide a ground for SIM 200; contact V_{PP} may provide a variable supply or programming voltage for SIM 200; and contact I/O may provide a data input/output path for SIM 200 to its CPU 240.

The user's account information on the SIM card 200 may play a number of roles. When paired with a device 100, it may uniquely identify the device 100 and its user on a network, allowing communications to be routed correctly. It may also provide accurate tracking of the user's use of the network.

Another feature of the SIM card 200 is that it may be portable. It may be removed from one device 100 and inserted into another, taking with it various information stored therein.

In an exemplary embodiment of the invention, a photo image of a user (i.e., a SIM owner) may be embedded securely (i.e., stored) in the secured, encrypted, and/or protected memory of SIM 200. In such an embodiment, this photo image may be used to validate traditional purchase transactions during which the user uses a credit or debit card to make the purchase, for example.

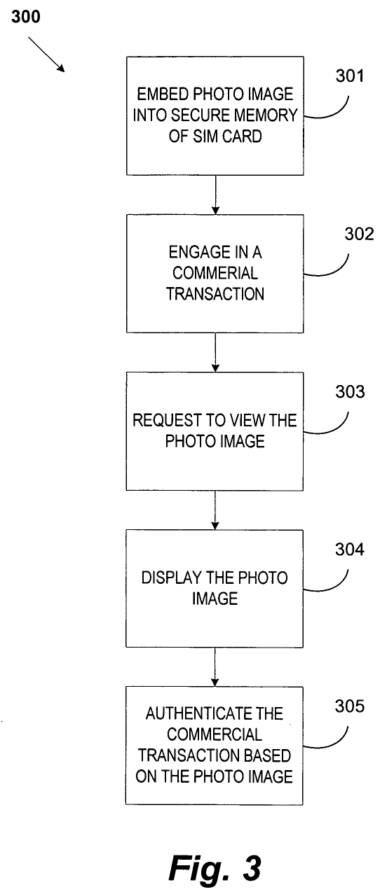

FIG. 3 depicts flow chart 300, which illustrates a method for using a photo image that may have been embedded in a SIM card to validate a commercial transaction.

In block 301, a user's image may be embedded into the secured, encrypted, and/or protected memory of a SIM card. In one embodiment of the invention, when a service provider of a digital device, for example, initializes the SIM card, a photo image of the user may be taken and stored in the secured, encrypted, and/or protected memory of the SIM card. In an exemplary embodiment of the invention, the photo image may be taken by a digital camera that is integrated with a digital device and automatically embedded into the secured, encrypted, and/or protected memory of the SIM card by the digital device. Alternatively, in a further embodiment of the invention, the photo image may be taken by a camera that may not be integrated with a digital device, and the photo image may be subsequently transferred into the secured, encrypted, and/or protected memory of the SIM card. In such an embodiment, the SIM card may then be placed into the digital device by the user or the service provider, for example.

Further, in an exemplary embodiment of the invention, a crypto processor, such as, e.g., crypto co-processor 250, may also be used to allow crypto algorithms not only to regulate the use of certificates for authentication in electronic and/or mobile transactions, but also to digitally sign the photo image that may be displayed on a digital device.

In block 302, the user may engage in a commercial transaction, such as a purchase transaction, during which the photo image may be used to authenticate the transaction.

In block 303, a request may be made to view the photo image. In one embodiment of the invention, for example, when the user stands at a cash register or some other Point of Sale (PoS) terminal, the cashier may request to see the photo image that is stored in the secured, encrypted, and/or protected memory of the SIM card. In a further alternative embodiment of the invention, a PoS terminal, for example, may send an electronic signal to query a digital device to transmit the photo image to the PoS terminal. In such an embodiment, such a query may be made using a GSM/GPRS network or conducted over a short-range wireless protocol such as Bloetooth or IRDA, for example.

In block 304, the photo image may be displayed. In an exemplary embodiment of the invention, to display the photo image, the user may show the photo image (that may be displayed on a display of a digital device) to a cashier, for example, by pushing a button on the device. In a further embodiment of the invention, a user may use a biometric reader (not shown), such as a thumb print reader or a retinal scan device that may be coupled to the digital device to display the photo image on the device. Such an embodiment may provide a user-instigated method for accessing the secured, encrypted, and/or protected memory of the SIM card.

In block 305, the transaction may be authenticated based on the photo image. In an exemplary embodiment of the invention, a cashier, for example, may compare the photo image with the physical appearance of the user and authenticate the transaction if there is a positive match.

In still a further exemplary embodiment of the invention, the digital device may respond to an automatic query by a PoS terminal, for example, by automatically transmitting the photo image via a GSM/GPRS network, Bluetooth, or IRDA, for example, to the PoS terminal. Such an embodiment may provide a system-integrated method for accessing the secured, encrypted, and/or protected memory of the SIM card. In block 305, the transaction may be authenticated based on the photo image. In an exemplary embodiment of the invention, a cashier, for example, may compare the photo image displayed (on the PoS terminal, for example) with the physical appearance of the user and authenticate the transaction if there is a positive match.

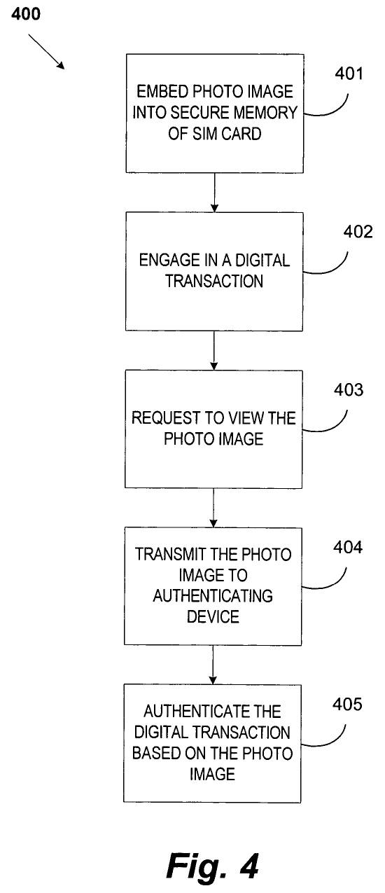

FIG. 4 depicts flow chart 400, which illustrates a method for using a photo image that may be embedded in a SIM card to validate a digital transaction. In an exemplary embodiment of the invention, during a digital transaction, for example, a digital device, such as device 100, may serve as an authentication device and/or a payment device.

In block 401, a user's image may be embedded into the secured, encrypted, and/or protected memory of the SIM card using methods similar to those described with respect to block 301 in FIG. 3.

In block 402, the user may engage in a digital transaction. In an exemplary embodiment of the invention, during a digital transaction, a digital device may transmit both payment information and authentication information, such as the photo image, to a PoS terminal for example. In mobile commerce, for example, current payment procedures may be based on simple message exchange via short-messaging-services (SMS) or the wireless application protocol (WAP), for example; however, they are not necessarily limited thereto. Some mobile payment (MP) services use dual-slot or dual-chip-phones. Dual-slotphone technologies may use the regular SIM card to identify the mobile device and may also provide a second card-slot for a credit/debit card integrated within the mobile phone. When paying for a service or good, the user may be asked to insert his credit or debit card into this second slot and to enter the card's PIN (Personal Identification Number). The phone may then serve as a regular payment terminal, similar to the ones already used with stationary merchants. Dual-SIM technologies may operate in a similar manner. However, since the second card (i.e., a credit or debit card, which may be the size of a SIM card) may already be integrated into the mobile device, an extra slot may not be needed. Therefore, some of the shortcomings of the dual-slot technology (e.g., usually heavier devices) may be overcome. Another application used within some payment models are special software tools needed on the customer side, e.g., to generate digital cash or upload a digital wallet.

In block 403, a request may be made to retrieve the photo image. In an exemplary embodiment of the invention, a PoS terminal may send an electronic signal to query a digital device to transmit the photo image to the PoS terminal. In such an embodiment, such a query may be made using a GSM/GPRS network, Bluetooth, or IRDA, for example.

In block 404, the photo may be transmitted to an authenticating device. In an exemplary embodiment of the invention, the photo image may be transmitted from the digital device to the PoS terminal, for example. In such an embodiment, the PoS terminal may serve as the authenticating device or may pass the photo image on to a central authentication device, such as a database. In a further exemplary embodiment of the invention, the photo image may be transmitted directly to a central authentication device and/or database. In these embodiments, the photo image may be transmitted using a GSM/GPRS network, Bluetooth, or IRDA, for example.

In block 405, the transaction may be authenticated. In an exemplary embodiment of the invention, to authenticate the transaction, the transmitted photo image may be compared to a photo image that may be stored in a central authentication device, for example. In such an embodiment, the transmitted photo image may be compared with the stored photo image using known or as-yet-to-be-developed face recognition technologies, for example. If there is a positive match between the transmitted photo image and the stored photo image, the transaction may be authenticated.

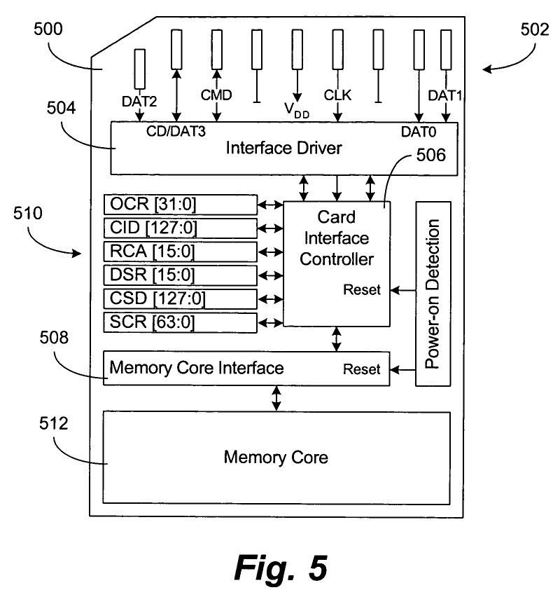

In other exemplary embodiments of the inventions, other forms of digital media for protected storage of the user's picture, a digital certificate, and/or a biometric representation of the user such as the user's fingerprint or retinal scan may be used without departing from the intent of the present invention in its broader aspects. For example, the SD (i.e., Secure Digital) memory card 500 shown in FIG. 5 may have a mechanical write-protect switch so that vital data may not be lost accidentally. Rails on both sides of the card may prevent it from being inserted inversely, and a notch may prevent the card coming out of its socket if the appliance is dropped or bumped. The metallic contacts 502 may be protected by ribs that may decrease the chances of damage by static electricity, or by contact damage such as scratching. For upward compatibility with the Multimedia Card (MMC), 1.4 mm rails may enable sockets to be provided that may accept an SD memory card 500 or an MMC.

The SD memory card 500 may communicate with three signal lines—CLK, CMD and DAT. These are defined as follows. CLK: CMD and DAT are synchronized to this CLK signal for input and output. CMD: The host may issue a command to the card and the card may return the response to the host. DAT: DAT is a bi-directional I/O terminal.

The card may comprise an I/F driver 504, card I/F controller 506, flash memory I/F 508, each register 510, and flash memory 512. Reading the information in the various registers may enable the application to exercise optimum control of the card and may enable the performance of the application to be improved. This may allow the application products to be compatible with cards of a broader range of generations and performance.

In order to provide for protected storage of the user's picture, a digital certificate, and/or a biometric representation of the user such as the user's fingerprint or retinal scan with such SD memory cards 500, the well-known Content Protection for Recordable Media (CPRM) technology may be used, for example. This protection may be enhanced in the SD memory cards 500 through the use of “key revocation” technology that may be built into the card.

The card's control circuitry may allow data to be read and written (in its protection area) only when appropriate external devices are detected. A check-out (copying) from a computer to the SD memory card 500 may be restricted during its initialization in compliance with known SD standards.

The SD memory card's copyright protection function may have the following features: access to the SD memory card 500 may be enabled by authentication between devices; and a random number may be generated each time there is mutual authentication and exchange of security information.

The following is an example of how the user's picture, digital certificate, and/or a biometric representation of the user such as the user's fingerprint or retinal scan may be protected on the SD memory card 500 of the present invention. Content, such as the user's picture, digital certificate, and/or a biometric representation of the user such as the user's fingerprint or retinal scan, may first be downloaded to a personal computer on a service provider's network. At this time the content may have been encrypted (e.g., network encryption) by an electronic distribution system. Before the content may be stored in the SD memory card 500, the personal computer may check whether the card is legitimate, and the card may check whether the personal computer software is a legitimate application. When mutual validation has been confirmed, the content may be encrypted in accordance with the key on each card and the key associated with the content. Simultaneously, the encrypted content information may be stored on the card.

In the same way, before the digital device 100 reads or displays the content from the card, the digital device 100 may check whether the card is legitimate, and the card may check whether the digital device 100 is a legitimate device. When mutual validation has been confirmed, the digital device 100 may acquire the key for decryption. Simultaneously, the encrypted content information may be read from the card 500, decrypted, and displayed upon request.

Apart from the area in the SD memory card 500 where the key is stored, there may be a protected area that may not be accessible without mutual authentication, and a data area that the user may access as with a normal memory card. If the content is to be stored, after successful authentication, the information (i.e., the user's picture, digital certificate, and/or a biometric representation of the user such as the user's fingerprint or retinal scan) in that content may be encrypted in accordance with a key that is unique for each card and stored in the protected area. Also, the information together with the card's own unique key may be encrypted and stored in the data area.

If the content is to be read out and reproduced, after successful authentication, the information in that content may be read from the protected area and decrypted in accordance with the key that is unique to each card. Also, the main body of the content that has been encrypted in the data area may be read, and the information and the card's own unique key area may be decrypted and made into information that may be reproduced.

SDIO (Secure Digital Input/Output) cards may also be used as identity module 200. An SDIO card may be an interface that extends the functionality of devices with SD card slots. A variety of SDIO cards exist and/or are being developed. The digital devices 100 of the present invention in such cases where SD memory cards, miniSD memory cards, MMC, SDIO, and the like may, thus, comprise, for example, personal computers, PDAs, digital cameras and the like. Likewise, the user's picture which may be stored within a protected area of such cards may be taken upon initialization by the wireless telephone service provider, or by the user herself or himself when the card is first installed in the digital device 100 having an integrated camera. A digital certificate and/or a biometric representation of the user such as the user's fingerprint or retinal scan may also be created and stored within the protected area of such cards during the same sequence of initialization events.

Although the embodiments of this invention have been described in terms of exemplary memory cards, it is to be understood that this invention applies to memory cards in general. For example, with the advent of 3G (third generation) mobile technology, the SIM card has evolved to become the Universal Subscriber Identity Module (USIM). The USIM application may provide features that equip it to play roles in various aspects of 3G. The USIM may also have the ability to store various applications for network services. Further smart card-related work continues within the European Telecommunications Standards Institute's Smart Card Platform Project (EP SCP). The EP SCP includes the USIM and/or the R-UIM (i.e., removable user identity module) application for access to systems. Additionally, where wireless access protocol (i.e., WAP) services are involved, the smart card may be known as a wireless identity module or WIM. Accordingly, it should be readily appreciated that by use of the term “identity module” herein, the present invention is equally applicable to SIMs, USIMs, R-UIMs and WIMs, as well as to other such modules, known and as yet to be developed.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. An apparatus, comprising:
a digital device; and
an identity module coupled to said digital device and including a secured memory to store a photo image of a user to be used for verifying the identity of the user.

2. The apparatus according to claim 1, further comprising:
a camera coupled to said digital device.

3. The apparatus according to claim 1, wherein said digital device comprises one of the group consisting of a wireless telephone, a personal digital assistant, and a personal computer.

4. The apparatus according to claim 2, wherein said camera is integrated with said digital device.

5. The apparatus according to claim 1, wherein said identity module comprises one of the group consisting of a subscriber identity module (SIM), a universal subscriber identity module (USIM), and a wireless application protocol identity module.

6. The apparatus according to claim 1, wherein said identity module comprises a secured digital (SD) card.

7. The apparatus according to claim 6, wherein said SD card comprises one of the group consisting of a miniSD card and a multimedia card.

8. The apparatus according to claim 1, wherein said secured memory is to include biometric identification data of the user stored therein.

9. The apparatus according to claim 8, further comprising a biometric identification data reader coupled to said digital device.

10. The apparatus according to claim 1, further comprising:
a secondary authentication module to store biometric identification data of the user and authenticate the user based on the biometric information data.

11. The apparatus according to claim 10, further comprising a biometric identification data reader coupled to said secondary authentication module.

12. A method, comprising:
providing at least one of the group consisting of hardware, software, and firmware to enable an identity module to store a photo image of a user in a secure memory portion of the identity module, wherein the identity module is for coupling with a digital communications device and the photo image is to be used for authorizing a transaction of the user.

13. The method according to claim 12, wherein only a first type of use of the digital communications device is permissible prior to storing the photo image in the secure memory portion of the identity module, and wherein other types of uses of the digital communications device are permissible after the photo image is stored in the secure memory portion of the identity module.

14. The method according to claim 12, wherein the transaction is a commercial transaction.

15. The method according to claim 14, wherein the commercial transaction is based on a credit account.

16. The method according to claim 14, wherein the commercial transaction is based on a debit account.

17. The method according to claim 14, further comprising:
prompting said secure memory portion to display said photo image upon execution of said transaction; and
authorizing said commercial transaction only upon verifying the user of the digital communications device is the person shown in said photo image.

18. The method according to claim 17, further comprising displaying said photo image on the digital communications device.

19. The method according to claim 17, further comprising:
establishing a communications link between the digital communications device and a point-of-sale (POS) terminal having a display; and
upon execution of said transaction, displaying said picture on said display of said POS terminal.

20. The method according to claim 17, comprising during said prompting, using biometric identification data of the user to display the photo image.

21. The method according to claim 17, comprising during said prompting, querying the digital communication device to transmit the photo image to a point of sale terminal.

22. A method, comprising:
receiving information about a purchase transaction;
requesting a photo image of a purchaser that is stored in a secure memory portion of a digital communications device of the purchaser; and
authorizing the purchase transaction based on the photo image.

23. The method according to claim 22, further comprising:
comparing the photo image to a physical appearance of the purchaser; and
authorizing the purchase transaction based on a positive match.

24. The method according to claim 22, further comprising:
comparing the photo image to a previously stored image of the purchaser; and
authorizing the purchase transaction based on a positive match.

25. The method according to claim 24, said comparing comprising using face-recognition technology to automatically compare the photo image to the previously stored image of the purchaser.

26. A machine accessible medium containing program instructions that, when executed by a processor, cause the processor to perform at least one operation comprising:
storing, in a secure memory portion of an identity module, a photo image of a user, the photo image to be used when authorizing a commercial transaction of the user.

27. (canceled)

28. The machine accessible medium according to claim 26, wherein said identity module comprises one of the group consisting of a subscriber identity module (SIM), a universal subscriber identity module (USIM), and a wireless application protocol identity module.

29. The machine accessible medium according to claim 26, wherein said identity module comprises a secured digital (SD) card.

30. The machine accessible medium according to claim 29, wherein said SD card comprises one of the group consisting of a miniSD card and a multimedia card.

31. A system, comprising:
a point of sale terminal;
a commercial transaction authorization module coupled to the point of sale terminal; and
a digital device to communicate with said point of sale terminal, said digital device including an identity module coupled to said digital device and including a secured memory to store a photo image of a user to be used for verifying the identity of the user.

32. The system according to claim 31, wherein said identity module comprises one of the group consisting of a subscriber identity module (SIM), a universal subscriber identity module (USIM), and a wireless application protocol identity module.

33. The system according to claim 31, wherein during a commercial transaction, said point of sale terminal is to be used to receive information about a commercial transaction, request a photo image of a purchaser that is stored in a secure memory portion of a digital communications device of the purchaser and transmit at least one of the information or the photo image to the commercial transaction authorization module, and said commercial transaction authorization module is to be used to authorize the commercial transaction.

34. The system according to claim 33, wherein the commercial transaction authorization module uses facial recognition techniques to automatically authorize the commercial transaction.

35. The system according to claim 31, wherein said digital device comprises one of the group consisting of a wireless telephone, a personal digital assistant, and a personal computer.

36. The system according to claim 31, wherein said digital device communicate with said point of sale terminal via at least on wireless link.
